(19) United States
(12) Patent Application Publication
(10) Pub. No.: US 2011/0246923 A1
(43) Pub. Date: Oct. 6, 2011

(54) INFORMATION PROCESSING APPARATUS, INFORMATION PROCESSING METHOD AND PROGRAM

(76) Inventors: Shunichi KASAHARA, Kanagawa (JP); Tatsuhito Sato, Kanagawa (JP)

(21) Appl. No.: 13/074,584

(22) Filed: Mar. 29, 2011

(30) Foreign Application Priority Data
Apr. 5, 2010 (JP) P2010-087000

(51) Int. Cl. G06F 3/048

(52) U.S. Cl. 715/771

(57) ABSTRACT

There is provided an information processing apparatus including a display control unit that displays a plurality of objects for setting execution parameters when predetermined processing is performed in a display screen to be adjacent to each other and controls scrolling of the plurality of objects in the display screen in accordance with a user's operation, a parameter setting unit that sets execution conditions for performing the predetermined processing in accordance with a combination of the objects positioned in predetermined positions in the display screen, and a processing execution unit that performs the predetermined processing based on the execution conditions set by the parameter setting unit, wherein the display control unit causes, when one of the objects is operated by the user's operation, the operated object and the object adjacent to the operated object to scroll in the display screen.

### BACKGROUND OF THE INVENTION

1. Field of the Invention

The present invention relates to an information processing apparatus, an information processing method, and a program.

2. Description of the Related Art

When an information processing apparatus such as a computer is caused to perform predetermined processing, the user of the information processing apparatus is frequently requested to set various parameters necessary to perform the predetermined processing. Thus, the user sets suitable parameters by individually operating various parameters to cause the information processing apparatus to appropriately perform the desired processing. Therefore, such parameter settings could become a cause of reducing operability for a user who has not understood how to set which parameter.

Japanese Patent Application Laid-Open No. 2000-67219 focuses on various image processing operations in image processing applications as predetermined processing and discloses a technology to improve operability for processing images. Japanese Patent Application Laid-Open No. 2000-67219 discloses a method by which a filter is selected based on a user's operation and image processing corresponding to the selected filter is made to perform on image data to improve operability.

### SUMMARY OF THE INVENTION

Regardless of image processing as shown in Japanese Patent Application Laid-Open No. 2000-67219, some kinds of processing performed by an information processing apparatus request settings of a plurality of parameters. It is difficult for some of the plurality of parameters to illustrate which influence to have on processing. Therefore, when the plurality of parameters is individually set, the settings frequently weigh on the user, leading to reduced operability,

In light of the foregoing, it is desirable to provide an information processing apparatus, an information processing method, and a program capable of efficiently setting a plurality of parameters without causing reduced operability.

According to an embodiment of the present invention, there is provided an information processing apparatus including a display control unit that displays a plurality of objects for setting execution parameters when predetermined processing is performed in a display screen to be adjacent to each other and controls scrolling of the plurality of objects in the display screen in accordance with a user's operation; a parameter setting unit that sets execution conditions for performing the predetermined processing in accordance with a combination of the objects positioned in predetermined positions in the display screen; and a processing execution unit that performs the predetermined processing based on the execution conditions set by the parameter setting unit, wherein the display control unit causes, when one of the objects is operated by the user's operation, the operated object and the object adjacent to the operated object to scroll in the display screen.

A predetermined coefficient of static friction and a predetermined coefficient of dynamic friction are preferably set to between the objects adjacent to each other, and the display control unit preferably calculates, when a scrolling speed of the operated object is a predetermined threshold calculated based on the coefficient of static friction or more, the scrolling speed of the adjacent object based on the coefficient of dynamic friction.

The display control unit may cause, when the user's operation performed on the operated object includes the operation in a direction parallel to a scroll direction and the operation in the direction perpendicular to the scroll direction, also the object adjacent to the operated object to scroll together.

The display control unit may calculate, when the scrolling speed of the adjacent object is the predetermined threshold or more, the scroll speed of the object further adjacent to the adjacent object based on the coefficient of dynamic friction.

The display control unit may cause, when a predetermined operation body is close to or in contact with the object adjacent to the operated object, only the operated object to scroll.

According to another embodiment of the present invention, there is provided an information processing method, including the steps of displaying a plurality of objects for setting execution parameters when predetermined processing is performed in a display screen to be adjacent to each other; controlling scrolling of the objects in the display screen in accordance with a user's operation; setting execution conditions for performing the predetermined processing in accordance with a combination of the objects positioned in predetermined positions in the display screen; and performing the predetermined processing based on the set execution conditions, wherein in the step of controlling scrolling, when one of the objects is operated by the user's operation, the operated object and the object adjacent to the operated object are scrolled in the display screen.

According to still another embodiment of the present invention, there is provided a program causing a computer to realize a display control function that displays a plurality of objects for setting execution parameters when predetermined processing is performed in a display screen to be adjacent to each other, controls scrolling of the plurality of objects in the display screen in accordance with a user's operation, and when one of the objects is operated by the user's operation, causes the operated object and the object adjacent to the operated object to scroll in the display screen; a parameter setting function that sets execution conditions for performing the predetermined processing in accordance with a combination of the objects positioned in predetermined positions in the display screen; and a processing execution function that performs the predetermined processing based on the execution conditions set by the parameter setting function.

According to the embodiments of the present invention described above, a plurality of parameters can efficiently be set without causing reduced operability.

### BRIEF DESCRIPTION OF THE DRAWINGS

FIG. 1 is a block diagram showing a configuration of an information processing apparatus according to a first embodiment of the present invention;

FIG. 2A is an explanatory view illustrating an input position detection unit and a direction detection unit;

FIG. 2B is an explanatory view illustrating the input position detection unit and the direction detection unit;

FIG. 3A is a block diagram showing the configuration of a processing execution unit according to the embodiment;

FIG. 3B is a block diagram showing the configuration of the processing execution unit according to the embodiment;

FIG. 4 is an explanatory view exemplifying the configuration of a storage unit according to the embodiment;

FIG. 5 is an explanatory view exemplifying a database stored in the storage unit according to the embodiment;

FIG. 6 is an explanatory view illustrating the processing execution unit according to the embodiment;

FIG. 7 is an explanatory view exemplifying the database stored in the storage unit according to the embodiment;

FIG. 8 is an explanatory view exemplifying the database stored in the storage unit according to the embodiment;

FIG. 9 is an explanatory view illustrating an information processing method according to the embodiment;

FIG. 10 is an explanatory view illustrating the information processing method according to the embodiment;

FIG. 11 is an explanatory view illustrating the information processing method according to the embodiment;

FIG. 12 is an explanatory view illustrating the information processing method according to the embodiment;

FIG. 13 is an explanatory view illustrating the information processing method according to the embodiment;

FIG. 14 is an explanatory view illustrating the information processing method according to the embodiment;

FIG. 15 is an explanatory view illustrating the information processing method according to the embodiment;

FIG. 16 is an explanatory view illustrating the information processing method according to the embodiment;

FIG. 17 is an explanatory view illustrating the information processing method according to the embodiment;

FIG. 18 is a flowchart showing a flow of the information processing method according to an embodiment of the present invention; and

FIG. 19 is a block diagram showing a hardware configuration of the information processing apparatus according to an embodiment of the present invention.

### DETAILED DESCRIPTION OF THE EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Note that the description will be made in the following order:

(1) First Embodiment
(1-1) Configuration of information processing apparatus
(1-2) Display control of display screen exercised by display control unit
(1-3) Information processing method

(2) Hardware configuration of information processing apparatus according to an embodiment of the present invention

(3) Summary

### First Embodiment

### Configuration of Information Processing Apparatus

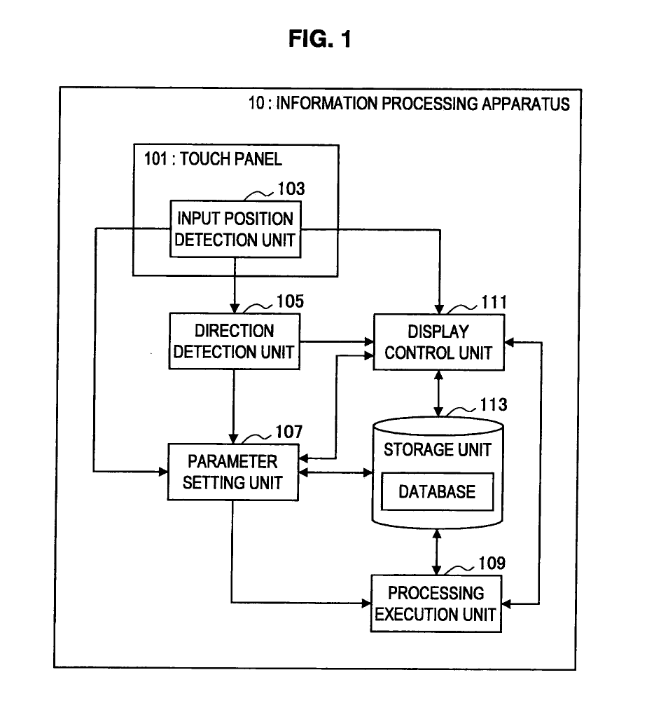

First, the configuration of an information processing apparatus according to a first embodiment of the present invention will be described with reference to FIG. 1. FIG. 1 is a block diagram showing the configuration of the information processing apparatus according to the present embodiment.

An information processing apparatus 10 according to the present embodiment is, for example, an information processing apparatus including a touch panel as an input apparatus and the user can make a predetermined input to the information processing apparatus 10 by operating objects displayed in a display unit (not shown) via the touch panel. Alternatively, the display unit of the information processing apparatus 10 may be configured to include a touch panel.

A display screen as described below is displayed in the touch panel. Predetermined processing such as scrolling is performed on various kinds of information displayed in the touch panel in accordance with contact or movement of an operation body 12. A special processing area may be provided in the touch panel. In the special processing area, for example, an object such as an icon to perform predetermined processing is displayed and the predetermined processing associated with the displayed object is performed by the special processing area being selected.

The information processing apparatus 10 is not limited to performing only predetermined processing such as the selection of an object or movement of display contents in response to contact or movement of the operation body 12. If, for example, the operation body 12 moves by drawing a predetermined locus in a state in which the operation body 12 is in contact with the touch panel, the information processing apparatus 10 performs predetermined processing corresponding to the locus drawn by the operation body 12. That is, the information processing apparatus 10 has a gesture input function. If, for example, a predetermined gesture is input, an application associated with the gesture is activated or predetermined processing associated with the gesture is performed.

As the operation body 12, for example, a finger of the user is used. Alternatively, for example, a stylus or touch pen may also be used as the operation body 12. If the touch panel is of optical type, any object could become the operation body 12. For example, if the touch panel is of optical type, a soft tool such as a brush that is hard to press against the touch panel can also be used as the operation body 12. Further, if the touch panel is an optical touch panel of in-cell type, any object whose shadow is cast on the touch panel can be used as the operation body 12.

The optical touch panel of in-cell type will briefly be described. There are several types of optical touch panels. For example, the optical touch panel of a mode in which an optical sensor is provided in an outer frame of a liquid crystal panel constituting a liquid crystal display and the position and moving direction of the operation body 12 in contact with the liquid crystal panel are detected by the optical sensor is relatively known. In contrast to this mode, the optical touch panel of in-cell type has an optical sensor array mounted in the liquid crystal panel and detects the position and moving direction of the operation body 12 that comes into contact with or comes close to the liquid crystal panel by the optical sensor array.

More specifically, an optical sensor and a lead circuit are formed on a glass substrate of the optical touch panel and a shadow of the operation body 12 is recognized by light incident from outside being detected by the optical sensor and strength thereof being read by the lead circuit. Thus, the optical touch panel of in-cell type can recognize the shape, contact area and the like of the operation body 12 based on the shadow of the operation body 12. Therefore, the operation by the contact “surface”, which is deemed difficult to realize by optical touch panels of other types, can be realized. Moreover, by applying optical touch panels of in-cell type, advantages such as improvement of recognition precision, improvement of display quality and further, improvement of designability of liquid crystal displays and the like containing an optical touch panel of in-cell type are gained.

As illustrated in FIG. 1, the information processing apparatus 10 mainly includes a touch panel 101, an input position detection unit 103, a direction detection unit 105, a parameter setting unit 107, a processing execution unit 109, a display control unit 111, and a storage unit 113.

The touch panel 101 is, as described above, an operation input unit provided in the information processing apparatus 10 according to the present embodiment. The touch panel 101 may be an optical touch panel described above or an optical touch panel of in-cell type. The touch panel 101 may be formed integrally with a display unit (not shown) such as a display device included in the information processing apparatus 10 or separately. The touch panel 101 further includes the input position detection unit 103.

The input position detection unit 103 detects the position of the touch panel 101 touched by the operation body 12. The input position detection unit 103 may be configured to detect a pressing force applied to the touch panel 101 when touched by the operation body 12. The input position detection unit 103 may have a function to detect the presence of the operation body 12 in a space over the touch panel 101 and close to the touch panel 101 even if the operation body 12 is not directly in contact and to recognize as a contact position. That is, the contact position here may contain position information for an operation performed by the operation body 12 as if to draw in the air over the screen of the touch panel 101.

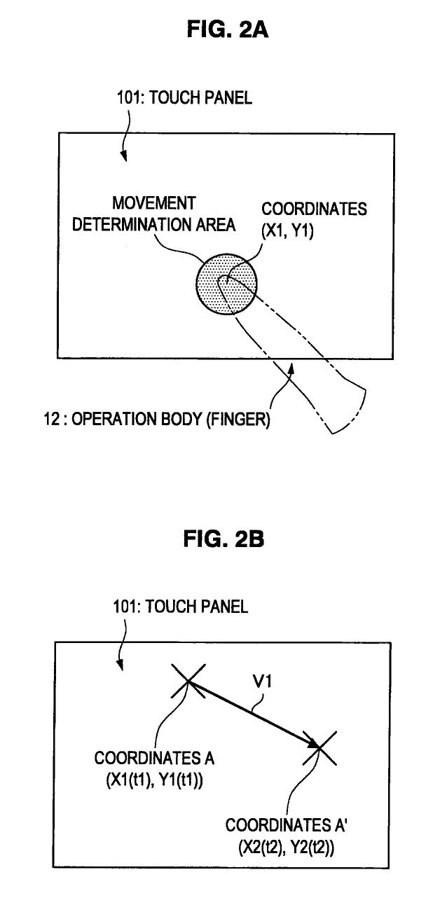

The input position detection unit 103 outputs information about the detected contact position (more specifically, coordinates of the contact position) to the direction detection unit 105, the parameter setting unit 107, and the display control unit 111 as input position information. If, for example, as shown in FIG. 2A, the number of detected contact positions is one, the input position detection unit 103 outputs one pair of coordinates (X1, Y1) as input position information. If the number of detected contact positions is two, the input position detection unit 103 can output a plurality of detected coordinates.

The direction detection unit 105 is realized by a CPU (Central Processing Unit), ROM (Read Only Memory), RAM (Random Access Memory) and the like. The direction detection unit 105 detects the moving direction of the operation body 12 by using coordinates, which are input position information output from the input position detection unit 103.

More specifically, the direction detection unit 105 detects the moving direction of the operation body 12 based on changes in input position information output at predetermined time intervals (for example, every several milliseconds to several hundred milliseconds). For example, as shown in FIG. 2A, the direction detection unit 105 has set therein a movement determination area used for determining whether the operation body 12 is moving. The movement determination area can be set to any dimensions depending on performance of resolution or the like that can distinguish two adjacent contact positions in the touch panel 101 and can be set to, for example, a radius of about 10 pixels. If the transmitted input position information changes beyond the range of the movement determination area, the direction detection unit 105 determines that the operation body 12 has moved. If the transmitted input position information changes within the range of the movement determination area, the direction detection unit 105 can determine that a so-called tapping operation has been performed by the operation body 12. The determination as to whether the operation body 12 has moved is made for all input position information transmitted in the same timing. That is, if two pairs of coordinates are transmitted in the same timing as input position information, the direction detection unit 105 makes the determination described above for temporal changes of each of the two pairs of coordinates.

If the transmitted input position information changes beyond the range of the movement determination area, the direction detection unit 105 detects the direction of a vector formed by a locus drawn by the transmitted input position information with temporal changes as the moving direction. The magnitude of the vector becomes the amount of movement of the operation body 12.

Consider, for example, as shown in FIG. 2B, a case when coordinates A (X1 (t1), Y1 (t1)) are transmitted from the input position detection unit 103 at time t1 and the position at time t2 corresponding to the input position information is coordinates A′ (X2 (t2), Y2 (t2)). In this case, the direction detection unit 105 detects the direction represented by a vector V1 defined by the start coordinates A and the end coordinates A′ as the moving direction of the operation body 12 that has touched the coordinates A. The direction detection unit 105 also sets the magnitude of the vector V1 as the amount of movement of the operation unit 12.

The direction detection unit 105 can calculate the movement speed of the operation body 12 by using the detected amount of movement of the operation body 12 and a time difference. Further, the direction detection unit 105 can also calculate the acceleration of the operation body 12 by using calculated movement speeds and a time difference. By focusing on the movement speed or acceleration, whether an operation performed by the operation body 12 is a so-called flick operation (operation to flick the touch panel) can be determined.

The direction detection unit 105 transmits direction information containing the moving direction and amount of movement of the operation body 12 detected as described above to the parameter setting unit 107 and the display control unit 111.

The parameter setting unit 107 is realized by, for example, a CPU, a ROM, or a RAM. The parameter setting unit 107 sets parameters (execution conditions) used for performing processing that can be performed by the processing execution unit 109 described later in the information processing apparatus 10. In the information processing apparatus 10 according to the present embodiment, as described more specifically below, parameters used when processing is performed are decided in accordance with a combination of objects positioned in predetermined positions inside the display screen.

After setting parameters in accordance with a combination of objects displayed inside the display screen, the parameter setting unit 107 outputs information about set parameters to the processing execution unit 109 described later.

Concrete examples of parameter setting processing performed by the parameter setting unit 107 will be described again in detail below.

The processing execution unit 109 is realized by, for example, a CPU, a ROM, or a RAM. The processing execution unit 109 performs predetermined processing that can be performed in the information processing apparatus 10 based on parameters (execution conditions) set by the parameter setting unit 107. The progress or execution results of processing performed by the processing execution unit 109 are displayed in a display unit (not shown) such as a display via the display control unit 111. When performing predetermined processing, the processing execution unit 109 can use various databases or programs stored in the storage unit 113 or the like.

Details of the processing execution unit 109 will be described again below by showing a concrete example.

The display control unit 111 is realized by, for example, a CPU, a ROM, or a RAM. The display control unit 111 is a processing unit that exercises display control of content of the display screen displayed in the display unit included in the information processing apparatus 10. More specifically, the display control unit 111 exercises display control of various objects such as a mouse pointer, icons, and scroll bar based on information about the moving direction and the like of the operation body 12 output from the input position detection unit 103 and the direction detection unit 105. The display control unit 111 also exercises display control when the progress or execution results of processing performed by the processing execution unit 109 are displayed in the display screen. Processing performed by the processing execution unit 109 is displayed in the display unit by various graphical user interfaces (GUI). Therefore, the display control unit 111 exercises display control of various GUIs displayed in the display screen of the display unit. Such GUIs may be stored in, for example, the storage unit 113 or may be acquired by the information processing apparatus 10 via various networks such as the Internet.

The display control exercised by the display control unit 111 will be described again below in detail.

When exercising the above display control, the display control unit 111 can use various kinds of information, programs, and databases stored in the storage unit 113 or the like.

The storage unit 113 is an example of a storage device included in the information processing apparatus 10 according to the present embodiment. In the storage unit 113, various databases and various kinds of data used when the parameter setting unit 107 or the processing execution unit 109 performs various kinds of processing are stored.

In the storage unit 113, various kinds of history information such as history information about parameter settings and history information about execution results of various kinds of processing performed by the processing execution unit 109 may be recorded. Further, various parameters necessary to store when the information processing apparatus 10 according to the present embodiment performs some kind of processing, the progress of processing, and various databases are recorded in the storage unit 113 when appropriate.

Each processing unit included in the information processing apparatus 10 can freely read/write information from/to the storage unit 113.

### [Concrete Example of the Processing Execution Unit]

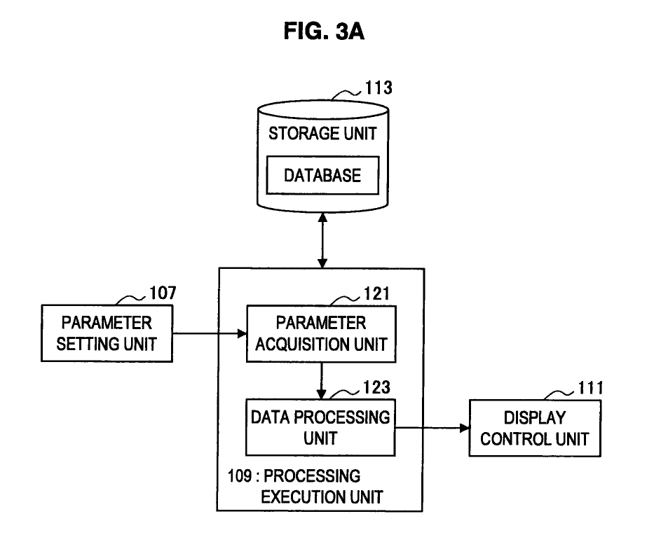

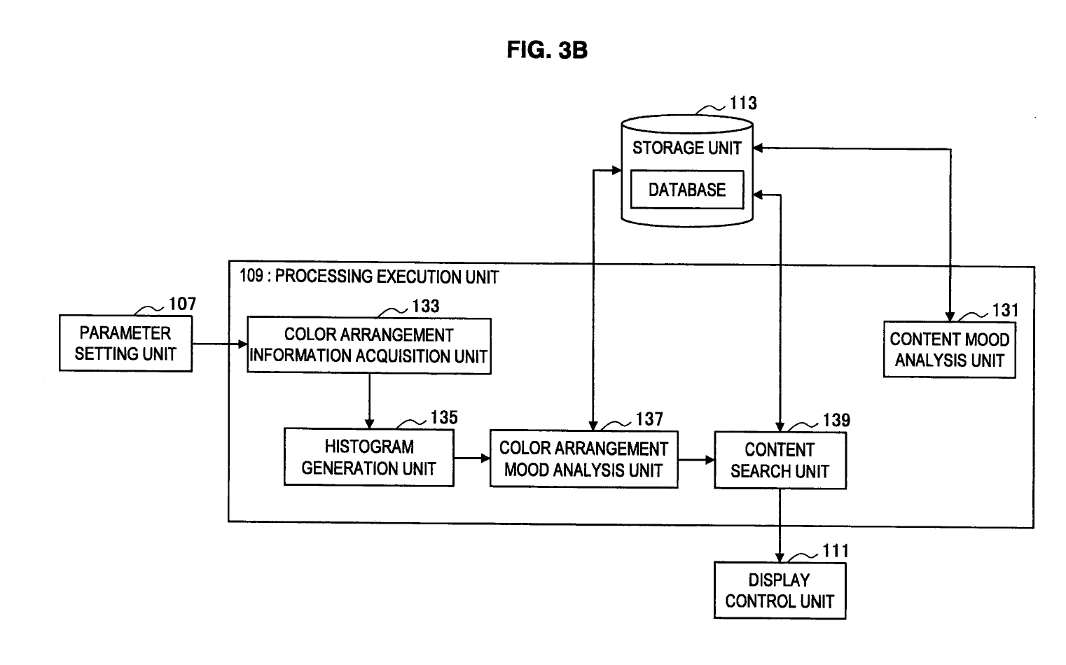

Subsequently, a concrete example of the processing execution unit 109 will briefly be described with reference to FIGS. 3A and 3B. FIGS. 3A and 3B are block diagrams showing the configuration of the processing execution unit according to the present embodiment.

FIG. 3A is an example of the configuration of the processing execution unit 109 according to the present embodiment. In this example, as shown in FIG. 3A, the processing execution unit 109 further includes a parameter acquisition unit 121 and a data processing unit 123.

The parameter acquisition unit 121 is realized by, for example, a CPU, a ROM, or a RAM. The parameter acquisition unit 121 acquires parameters, which are information about execution conditions of processing set by the parameter setting unit 107, and outputs parameters to the data processing unit 123.

The data processing unit 123 is realized by, for example, a CPU, a ROM, or a RAM. The data processing unit 123 performs processing on various kinds of data based on parameters output from the parameter acquisition unit 121. Examples of data processing performed by the data processing unit 123 include, for example, processing to apply different colors specified by parameters to various images displayed in the display screen, processing to search for data satisfying conditions from a plurality of pieces of data, and processing to change the tone or the like of various kinds of pieces of music data. These kinds of processing are only examples and processing that can be performed by the data processing unit 123 according to the present embodiment is not limited to the above examples.

When predetermined data processing is performed based on parameters output from the parameter acquisition unit 121, the data processing unit 123 outputs processing results of the data processing to the display control unit 111. Accordingly, results of processing performed by the data processing unit 123 are displayed in a display unit (not shown) such as a display.

FIG. 3B is another example different from the example in FIG. 3A of the configuration of the processing execution unit 109 according to the present embodiment. In this case, the parameter setting unit 107 outputs information about a color combination (hereinafter, referred to as color arrangement information) as parameters and the processing execution unit 109 performs processing to search for content stored in the storage unit 113 or the like based on the color arrangement information.

In this example, as shown in FIG. 3B, the processing execution unit 109 further includes a content mood analysis unit, a color arrangement information acquisition unit 133, a histogram generation unit 135, a color arrangement mood analysis unit 137, and a content search unit 139.

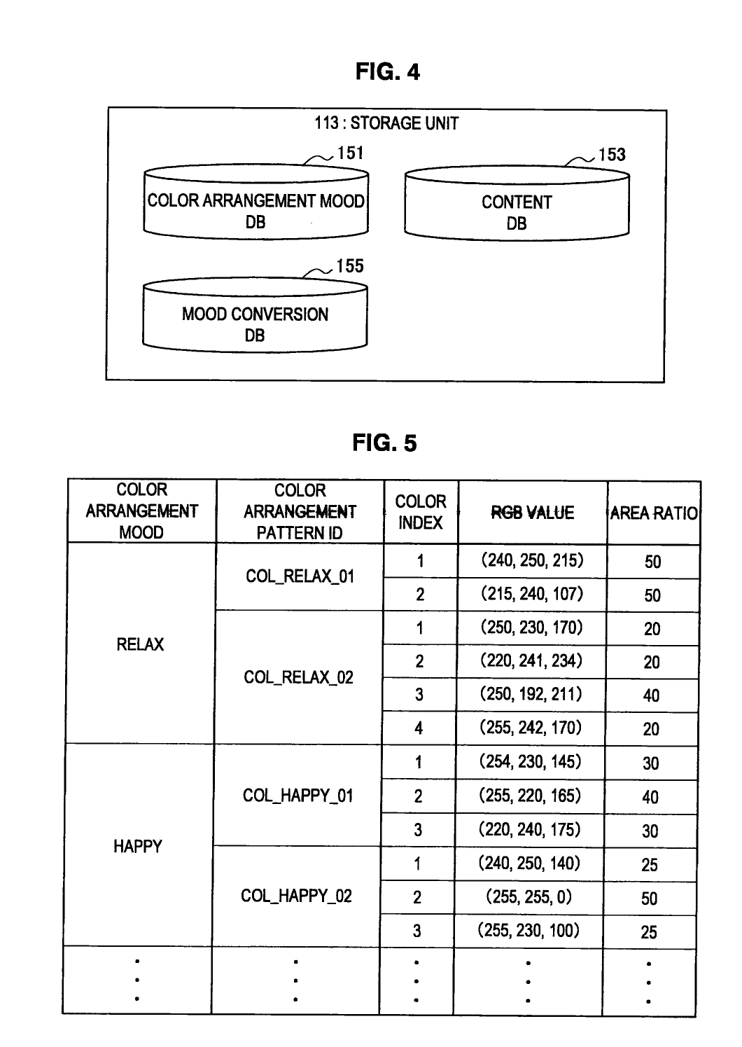

Before describing these processing units, databases stored in the storage unit 113 will be first described with reference to FIG. 4. FIG. 4 is an explanatory view exemplifying the configuration of a storage unit according to the present embodiment.

When the processing execution unit 109 shown in FIG. 3B performs the processing described below, the processing execution unit 109 uses various databases (DB) stored in the storage unit 113 as shown in FIG. 4. As shown in FIG. 4, the storage unit 113 has a color arrangement mood DB 151, a content DB 153, and a mood conversion DB 155 stored therein.

The color arrangement mood DB 151 is a database recording correspondences between color arrangement information about color combinations and color arrangement moods concerning an atmosphere provided to a person by the color combination. In FIG. 5, for example, “RELAX” and “HAPPY” are shown as the color arrangement mood (that is, an atmosphere provided to a person by some color combination). The color arrangement mood “RELAX” means a color combination that provides an atmosphere of relaxation to a person who views the color combination belonging to this color arrangement mood. Similarly, the color arrangement mood “HAPPY” means a color combination that provides a feeling of happiness to a person who views the color combination belonging to this color arrangement mood.

In the example shown in FIG. 5, two color arrangement patterns (that is, color combinations) are associated with the color arrangement mood “RELAX”. The color combination (that is, color arrangement information) to which the color arrangement pattern ID “COL_RELAX_{—}01” is attached means a combination of a color (color to which the color INDEX=1 is attached) represented by RGB values (240, 250, 215) and a color (color to which the color INDEX=2 is attached) represented by RGB values (215, 240, 107) in an area ratio of 50:50. Similarly, the color combination (color arrangement information) to which the color arrangement pattern ID “COL_RELAX_{—}02” is attached means a combination of four colors to which color INDEXES=1 to 4 are attached in an area ratio of 20:20:40:20. Thus, in the color arrangement mood DB 151, one color arrangement mood is associated with one or a plurality of color combinations (color arrangement information) belonging to the color arrangement mood.

Each piece of color arrangement information is constituted of a plurality of colors in the example shown in FIG. 5, but the color arrangement information may be constituted of one color.

The color arrangement mood registered with the color arrangement mood DB 151 is not limited to the example shown in FIG. 5 and atmospheres related to any abstract notion provided to a person by color combinations such as human emotions, comfort/discomfort, senses of cold/warmth, and senses of heaviness/lightness may also be registered. In addition to the example shown in FIG. 5, examples of the color arrangement mood include, for example, COLD, WARM, HEAVY, LIGHT, SPORTY, CUTE, ADULT, CHILDISH, URBAN, and EXECUTIVE.

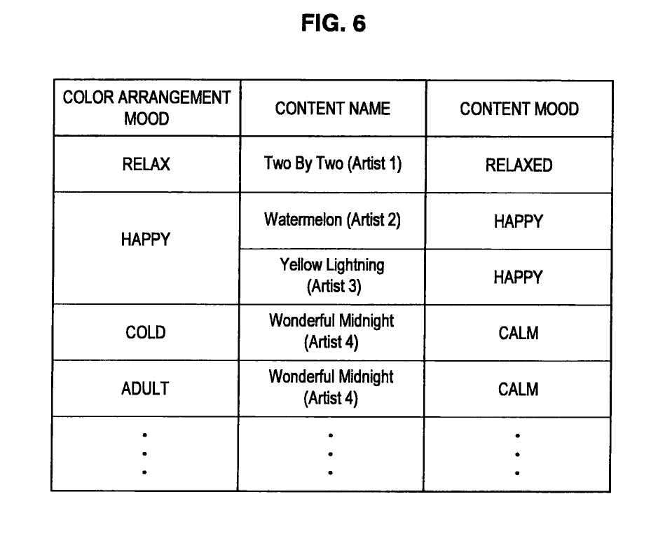

The content DB 153 is a database recording information about content stored in the storage unit 113. As shown in FIG. 6, this database records metadata about the content mood (hereinafter, referred to as a mood label) described below and metadata about the color arrangement mood for each piece of content. Though other metadata associated with content is not recorded in the content DB 153 shown in FIG. 6, various kinds of metadata such as the storage location of real data, storage location of real data of thumbnail images and jacket photos, and genres of content are associated with each piece of content.

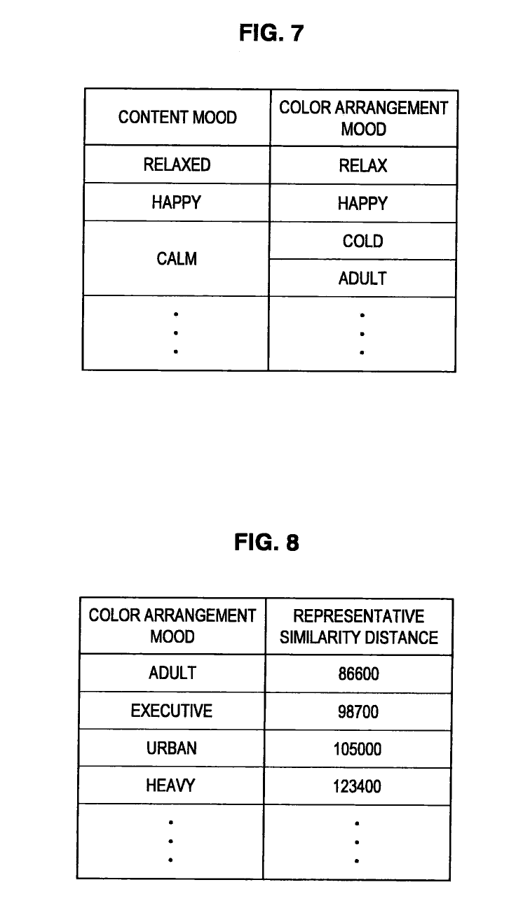

As shown in FIG. 7, the mood conversion DB 155 is a database recording correspondences between the content mood and color arrangement mood. The processing execution unit 109 can decide the color arrangement mood corresponding to content from the mood label of each piece of content by referring to the mood conversion DB 155.

In the foregoing, examples of databases stored in the storage unit 113 have been concretely described.

The content mood analysis unit 131 is realized by, for example, a CPU, a ROM, or a RAM. The content mood analysis unit 131 analyzes an atmosphere (mood) provided by content stored in the storage unit 113 to people who have viewed the content.

Atmospheres provided by content include, for example, those representing human emotions such as “happy”, “cheerful”, “sad”, “light”, and “heavy”, senses of heaviness/lightness, and comfort/discomfort. Content to be analyzed by the content mood analysis unit 131 includes, for example, image content such as still images and dynamic images, music content such as music data, text content, and Web pages.

The content mood analysis unit 131 can analyze not only real data of content, but also various kinds of metadata (for example, thumbnail images of content, jacket photos, and genres of content) associated with content.

Music content will be taken as an example of content in the description below.

The content mood analysis unit 131 acquires music content (including metadata) stored in the storage unit 113 and extracts a characteristic quantity of the music content using a method disclosed by Japanese Patent Application Laid-Open No. 2007-121457 or the like. Then, the content mood analysis unit 131 analyzes the content specific atmosphere (hereinafter, referred to also as the content mood) provided by content to people based on the extracted characteristic quantity.

Based on analysis processing of the content mood performed by the content mood analysis unit 131, metadata about the content mood is attached to each piece of content. The content mood analysis unit 131 adds the mood label obtained as a result of the analysis to the content DB 153 stored in the storage unit 113 as metadata. As a result, as shown in FIG. 6, the content DB 153 is updated.

Next, the content mood analysis unit 131 associates the content mood and color arrangement mood by referring to the mood conversion DB 155 stored in the storage unit 113. The content mood analysis unit 131 can decide the color arrangement mood corresponding to content by referring to the mood label, which is metadata associated with each piece of content, and using the mood label and the mood conversion DB 155. After the color arrangement mood corresponding to each piece of content is decided, the content mood analysis unit 131 reflects the results in the content DB 153.

The analysis processing of content by the content mood analysis unit 131 described above is performed in any timing.

The color arrangement information acquisition unit 133 is realized by, for example, a CPU, a ROM, or a RAM. The color arrangement information acquisition unit 133 acquires from the parameter setting unit 107 information (color arrangement information) about the combination of colors to be search conditions (search query) when the content search unit 139 described later searches for content. The color arrangement information acquisition unit 133 causes the display screen to display colors that can be selected by the user via the display control unit 111. The method of displaying colors that can be selected by the user is not specifically limited and the display screen may be caused to display a list of selectable colors as a color palette or the display screen may be caused to display a scroll bar in which the selectable color continuously changes by scroll processing. In this case, the user selects a combination of any colors by operating the touch panel 101 while viewing the display screen.

The color arrangement information acquisition unit 133 may also allow the user to specify by some method the ratio in which colors are combined. Accordingly, the area ratio occupied by each color can be determined. Alternatively, the color arrangement information acquisition unit 133 may set the area ratio equally for the selected color combination without allowing the user to specify the ratio in which colors are combined.

After color arrangement information is acquired from the parameter setting unit 107, the color arrangement information acquisition unit 133 outputs the acquired color arrangement information to the histogram generation unit 135.

The number of colors that can be selected by the user is not specifically limited, but it is preferable to select as many colors as possible from a color space to increase the selection of the user. Moreover, in consideration of the appearance of the display screen, it is preferable to constitute color patterns by selecting a tone of bright color combinations from a commonly used color circle by tone and adding gray-scale colors to the selected tone. The tone is a concept combining the lightness and chroma and a sense of unity can be provided to the display screen by using colors of the same tone or similar tones.

The histogram generation unit 135 is realized by, for example, a CPU, a ROM, or a RAM. The histogram generation unit 135 generates a color histogram based on color arrangement information output from the color arrangement information acquisition unit 133. The color histogram is information showing which color is contained in which ratio.

After a color histogram is generated based on color arrangement information output from the color arrangement information acquisition unit 133, the histogram generation unit 135 outputs the generated color histogram to the color arrangement mood analysis unit 137. Accordingly, the color arrangement mood analysis unit 137 can analyze the color arrangement mood corresponding to the color histogram.

The color arrangement mood analysis unit 137 is realized by, for example, a CPU, a ROM, or a RAM. The color arrangement mood analysis unit 137 analyzes information about a color histogram (that is, color arrangement information) output from the histogram generation unit 135 to determine the color arrangement mood corresponding to the color combination represented by the input color histogram.

The color arrangement mood analysis unit 137 first calculates a similarity distance between the color histogram (color arrangement information) output from the histogram generation unit 135 and color arrangement information registered with the color arrangement mood DB 151 by using the color arrangement mood DB 151 stored in the storage unit 113. In the description below, for convenience's sake, color arrangement information output from the histogram generation unit 135 is called input color arrangement information and color arrangement information registered with the color arrangement mood DB 151 is called registered color arrangement information.

The color arrangement mood analysis unit 137 calculates the similarity distance, which is an example of index indicating the degree of similarity between input color arrangement information and registered color arrangement information and the calculated similarity distance decreases with an increasing similarity between the input color arrangement information and registered color arrangement information.

The method of calculating the similarity distance used by the color arrangement mood analysis unit 137 is not specifically limited as long as the method can calculate a similarity distance between color arrangement information even if the number of colors or areas occupied by colors are different. As such a similarity distance, for example, the color arrangement mood analysis unit 137 can use “Earth Mover's Distance” (EMD) disclosed by, for example, WO 2007/114939. While details thereof are described in WO 2007/114939, the EMD is a similarity distance calculated by focusing on dimensions of an area occupied in a predetermined space (for example, the L*a*b space or the RGB space) by a color contained in some image and is a similarity distance calculated by using a distance (for example, a Euclidean distance or Hausdorff distance) d_{pq} between some color p and some color q and a quantity e_{pq} indicating how far an area occupied by the color p can be moved to an area occupied by the color q.

After input color arrangement information is acquired, the color arrangement mood analysis unit 137 focuses on one color arrangement mood (for example, RELAX shown in FIG. 5) registered with the color arrangement mood DB 151 to calculate a similarity distance between the input color arrangement information and all registered color arrangement information belonging to the focused color arrangement mood. That is, if RELAX shown in FIG. 5 is focused on, the color arrangement mood analysis unit 137 calculates a similarity distance between the input color arrangement information and the registered color arrangement information represented by “COL_RELAX_{—}01” and a similarity distance between the input color arrangement information and the registered color arrangement information represented by “COL_RELAX_{—}02”. After similarity distances between all registered color arrangement information belonging to the focused color arrangement mood and the input color arrangement information is calculated, the color arrangement mood analysis unit 137 identifies the shortest similarity distance among calculated similarity distances. The color arrangement mood analysis unit 137 determines the identified shortest similarity distance as a representative similarity distance between the input color arrangement information and the focused color arrangement mood.

The color arrangement mood analysis unit 137 calculates the above representative similarity distance for all color arrangement moods registered with the color arrangement mood DB. By performing such processing, for example, as shown in FIG. 8, the color arrangement mood analysis unit 137 can calculate representative similarity distances for all color arrangement moods. These representative similarity distances are quantification (digitization) of various atmospheres (color arrangement moods) of input color arrangement information.

When calculations of representative similarity distances for all color arrangement moods are completed, the color arrangement mood analysis unit 137 outputs the calculated representative similarity distances to the content search unit 139 described later. At this point, the color arrangement mood analysis unit 137 may individually output all calculated representative similarity distances to the content search unit 139 or output the calculated representative similarity distances to the content search unit 139 in a lookup table format as shown in FIG. 6. The color arrangement mood analysis unit 137 may store calculated representative similarity distances and similarity distances to registered color arrangement information belonging to each color arrangement mood in the storage unit 113 by associating with input color arrangement information. By storing correspondences between input color arrangement information and calculated similarity distances/representative similarity distances in the storage unit 113 or the like, time and efforts when representative similarity distances are calculated for the same input color arrangement information next time can be saved. When calculating a similarity distance between input color arrangement information and registered color arrangement information, the color arrangement mood analysis unit 137 can use various programs and other databases stored in the storage unit 113 or the like.

The content search unit 139 is realized by, for example, a CPU, a ROM, or a RAM. The content search unit 139 searches for content stored in the storage unit 113 or the like based on analysis results concerning the color arrangement mood output from the color arrangement mood analysis unit 137.

The content search unit 139 first selects one or a plurality of color arrangement moods in ascending order of value by referring to analysis results (for example, a list of representative similarity distances as shown in FIG. 8) concerning the color arrangement mood output from the color arrangement mood analysis unit 137. The number of color arrangement moods selected by the content search unit 139 is not specifically limited, but it is preferable to set the number thereof based on the size of the display screen or the like. By selecting the plurality of color arrangement moods, a plurality of kinds of content corresponding to the color arrangement mood that could correspond to the color arrangement information specified by the user can be selected and therefore, the selection of the user can be increased.

Next, the content search unit 139 selects content stored in the storage unit 113 or the like based on the selected color arrangement mood. More specifically, the content search unit 139 refers to the content DB 153 stored in the storage unit 113 to select content, the color arrangement mood associated with which matches the selected color arrangement mood. Accordingly, the processing execution unit 109 according to the present embodiment can search for concrete content by using an abstract concept of color combination as a search query.

The content search unit 139 outputs information about searched content to the display control unit 111. The display control unit 111 can present information about content selected by the user by causing the display screen of the display unit to display information about searched content.

In the foregoing, an example of the function of the information processing apparatus 10 has been shown. Each of the above structural elements may be configured by using common members or circuits or hardware specialized to the function of each structural element. Alternatively, the function of each structural element may all be executed by a CPU or the like. Therefore, elements to be used can be changed when appropriate in accordance with the technical level when the present invention is carried out.

A computer program to realize each function of an information processing apparatus according to the present embodiment described above may be created and implemented on a personal computer or the like. Alternatively, a computer-readable recording medium in which such a computer program is stored may be provided. The recording medium is, for example, a magnetic disk, optical disk, magneto-optical disk, or flash memory. The above computer program may be delivered via, for example, a network without using any recording medium.

### <Display Control of Display Screen Exercised by Display Control Unit>

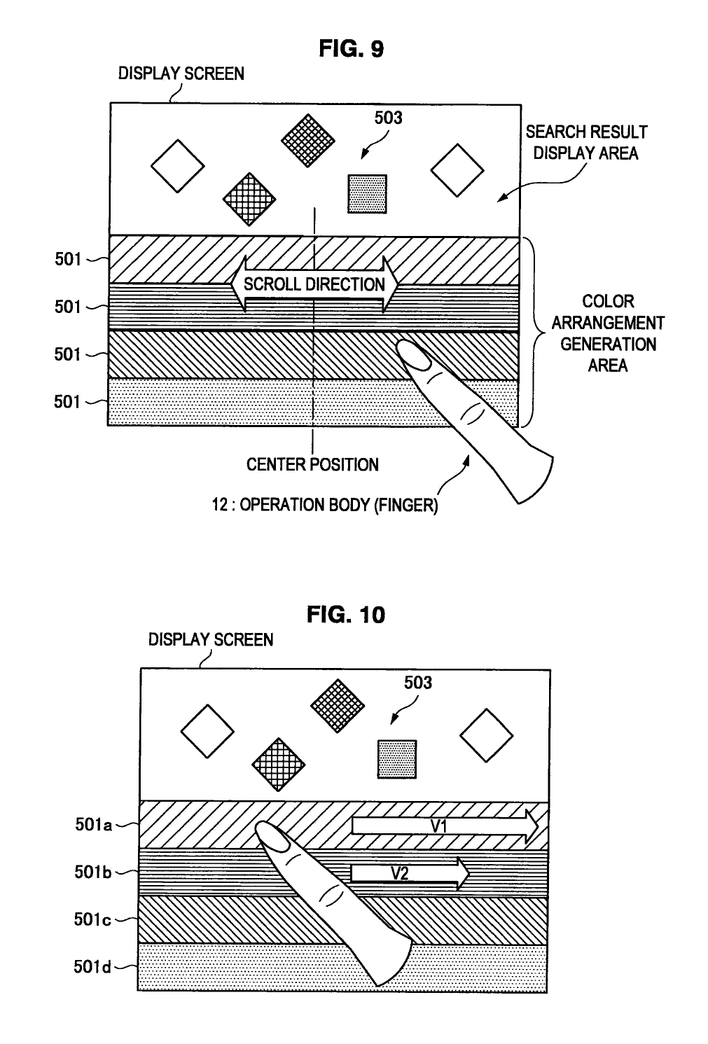

Next, the display control method of the display screen executed by the display control unit 111 according to the present embodiment will concretely be described in detail with reference to FIGS. 9 to 17. FIGS. 9 to 17 are explanatory views illustrating the display control method according to the present embodiment.

FIG. 9 is an explanatory view exemplifying the display screen when the processing execution unit 109 according to the present embodiment has the configuration shown in FIG. 3B. Content of the display screen displayed in the display unit is controlled, as described above, by the display control unit 111.

The display screen includes, as shown in FIG. 9, a color arrangement generation area in which a scroll bar 501 used by the user to select a combination of colors is displayed and a search result display area in which results of a search performed based on the color arrangement selected in the color arrangement generation area are displayed. The scroll bar 501 displayed in the color arrangement generation area is used as an object for setting parameters.

The user of the information processing apparatus 10 operates the scroll bar 501 displayed in the color arrangement generation area along a direction shown in FIG. 9 by using the operation body 12 such as a finger on the touch panel 101 to set a combination of colors desired by the user. In FIG. 9, the four scroll bars 501 are provided adjacent to each other. Therefore, in the example shown in FIG. 9, content is searched for after the user specifies a combination of four colors.

The user selects a desired combination of colors by moving each of the scroll bars 501 using the operation body 12 such as a finger. Each of the scroll bars 501 moves following the user's operation. It is preferable that the pattern of color displayed in each of the scroll bars 501 be identical. Accordingly, the user can freely combine colors just as the user thinks fit.

The color displayed in each of the scroll bars 501 can suitably be selected from, for example, a color circle by tone, but each of the scroll bars 501 can be caused to display, for example, combinations of colors below.

More specifically, a total of 42 colors may be displayed combining 15 colors obtained by dividing the color circle “Strong” into 15 colors, 15 colors obtained by dividing the color circle “Light” into 15 colors, six colors obtained by dividing the color circle “Pale” into six colors, and six colors obtained by dividing a gray scale into six colors of the color circle by tone.

When the combination of four colors is specified by the user, the information processing apparatus 10 searches for content according to the procedure described above. As a result, content associated with the color arrangement mood corresponding to the color combination selected by the user is searched for and an object 503 representing the searched content is displayed in the search result display area. Objects representing content include thumbnail images corresponding to a portion of contents of content and jacket photos of content.

The parameter setting unit 107 judges for each of the scroll bars 501 that the color displayed in a portion positioned in a substantial center (for example, within one pixel of the center) in the width direction as the color selected by the user. At this point, the parameter setting unit 107 uses information about the display position of each scroll bar acquired from the display control unit 111 and information output from each of the input position detection unit 103 and the direction detection unit 105 to decide a combination of colors positioned in a substantial center in the width direction. Therefore, with such processing performed, content is searched for each time the color in a substantial center portion in each of the scroll bars 501 changes and search results are displayed in the search result display area.

The display control unit 111 according to the present embodiment exercises scroll control of the scroll bars 501 as if a frictional force acts between scroll bars adjacent to each other. By considering such a pseudo frictional force and further artificially interpreting an operation on the scroll bar by the operation body 12 as an application of force to the scroll bar, the display control unit 111 exercises scroll control of the scroll bars as if an applied pseudo force propagates to adjacent scroll bars.

Therefore, when one of the scroll bars 501 is operated by the user, the display control unit 111 exercises scroll control of not only the operated scroll bar, but also scroll bars adjacent to the applicable scroll bar.

Consider, as shown in FIG. 10, for example, a case when a scroll bar 501a positioned in the uppermost portion of the color arrangement generation area is operated by the operation body. In the present embodiment, the coefficient of static friction and the coefficient of dynamic friction that are considered in general physics (dynamics) are set to between scroll bars adjacent to each other. Values of the coefficient of static friction and the coefficient of dynamic friction are not limited to specific values and any values can be decided when appropriate.

Since the (pseudo) coefficient of static friction is considered, if the speed of operation (that is, the movement speed of the operation body) V1 performed on the scroll bar 501a is a predetermined speed Vth or more decided based on the coefficient of static friction, the display control unit 111 scrolls a scroll bar 501b adjacent to the operated scroll bar 501a. Once the scroll bar 501b starts to scroll, it becomes necessary to consider the (pseudo) coefficient of dynamic friction between the scroll bars 501a and 501b and thus, the movement speed V2 of the scroll bar 501b becomes V2=αV1 using a predetermined threshold a decided based on the coefficient of dynamic friction. With such processing performed, the scroll bar 501b on which no operation has been performed is scrolled following the operated scroll bar 501a.

Similarly, if the speed V2 of the scroll bar 501b is the predetermined speed Vth or more, the display control unit 111 exercises the above scroll control for a scroll bar 501c adjacent to the scroll bar 501b.

Any value may be set to Vth used to determine whether or not to scroll a scroll bar and the coefficient α used to decide the speed of a scroll bar that scrolls by following and values calculated based on so-called equations of motion used in physics may be used for scroll bars adjacent to each other.

Thus, if an operation is performed on some scroll bar and predetermined conditions are met, the display control unit 111 exercises scroll control to cause also a scroll bar adjacent to the operated scroll bar to scroll. Thus, the information processing apparatus 10 according to the present embodiment can reduce user's operations when a plurality of parameters is set so that operability of the user can be improved.

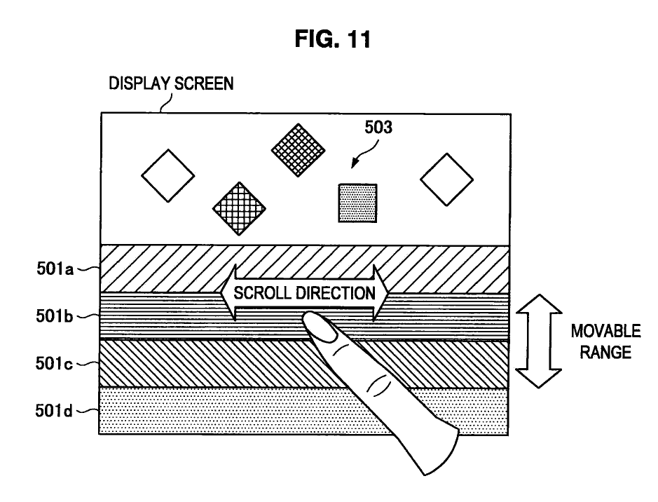

The scroll bar 501 shown in FIGS. 9 and 10 can be scrolled in the width direction of the display screen. Here, for example, as shown in FIG. 11, the display control unit 111 may exercise display control so that the user can move each of the scroll bars 501 also in a direction perpendicular to the scroll direction. By exercising such display control, the user can perform an operation to cause the scroll bar 501 to scroll to the left or to the right while pushing the scroll bar 501 to be scrolled toward a scroll bar adjacent to the scroll bar to be operated.

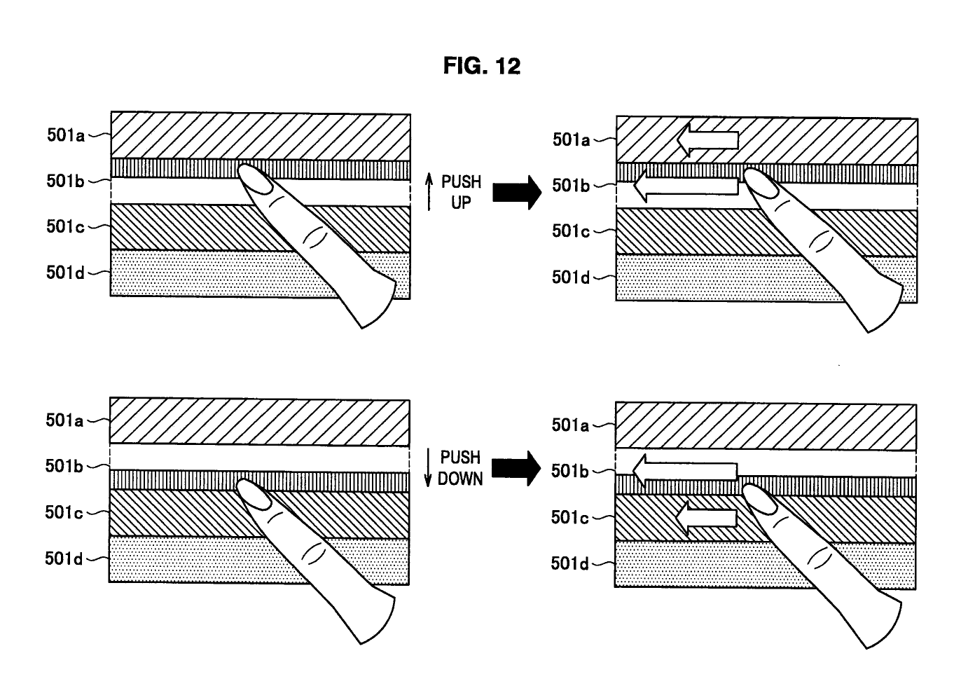

Consider, for example, as shown in an upper part of FIG. 12, a case when the user performs a scroll operation of the scroll bar 501b by pushing up the scroll bar 501b toward the scroll bar 501a. In this case, the display control unit 111 judges that the user wants to scroll both the scroll bar 501a and the scroll bar 501b and exercises scroll control of both the scroll bar 501a and the scroll bar 501b.

Consider, for example, as shown in a lower part of FIG. 12, a case when the user performs a scroll operation of the scroll bar 501b by pushing down the scroll bar 501b toward the scroll bar 501c. In this case, the display control unit 111 judges that the user wants to scroll both the scroll bar 501b and the scroll bar 501c and exercises scroll control of both the scroll bar 501b and the scroll bar 501c.

In each figure in FIG. 12, the operation performed by the user on the scroll bar 501b may be an operation to drag the scroll bar 501b in an oblique direction (in the example in FIG. 12, in an upper left direction or a lower left direction). Alternatively, the operation performed on the scroll bar 501b may be a flick operation of the scroll bar 501b in an oblique direction.

By permitting movement of a scroll bar also in a direction perpendicular to the scroll direction so that the above operations can be realized, the user can explicitly input an operation of operating two scroll bars or more into the information processing apparatus 10. Therefore, even if the movement speed V1 of the scroll bar to be operated is less than the predetermined threshold Vth, the display control unit 111 may exercise scroll control of adjacent scroll bars in consideration of an explicit input operation by the user.

The movement speed of each scroll bar when the above push-up (or push-down) operation is performed is preferably determined by the method described with reference to FIG. 10.

If the movement speed V2 of the scroll bar 501c is the predetermined threshold Vth or more in a situation shown in the lower part of FIG. 12, a scroll bar 501d also scrolls following the scroll of the scroll bar 501c.

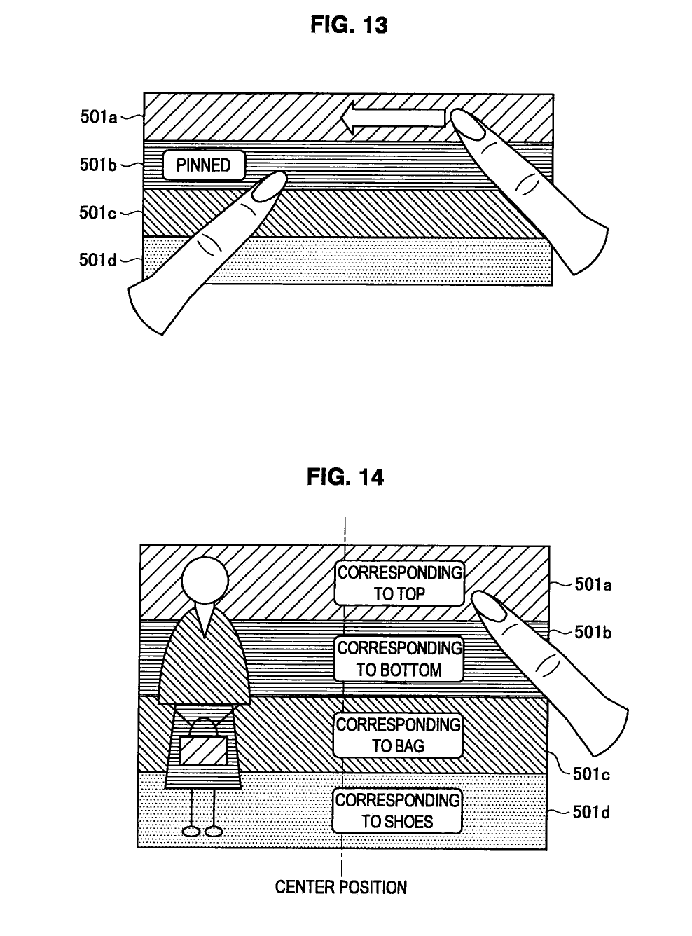

The user may not want to cause an adjacent scroll bar to scroll by following the operated scroll bar. In such a case, as shown in FIG. 13, the user brings the operation body 12 close to or into contact with the scroll bar that should not be scrolled to put the scroll bar that should not be scrolled into a so-called pinned state. If a plurality of input positions of the operation body 12 is present and there is, among the plurality of input positions, an input position whose position does not change over time, the display control unit 111 judges that such a pinning operation has been performed and does not exercise scroll control of the applicable scroll bar. Accordingly, even if the user scrolls a scroll bar adjacent to a pinned scroll bar, the pinned scroll bar can be stopped without being scrolled.

In the example shown in FIG. 13, the display control unit 111 judges that the scroll bar 501b is pinned by the operation body. Thus, even if scroll control of the scroll bar 501a should be exercised, the display control unit 111 causes the scroll bar 501b to stand still in the currently displayed position without causing the scroll bar 501b to scroll following the scroll bar 501a.

The display screens shown in FIGS. 9 to 13 are examples of the display screen when the processing execution unit 109 performs search processing of content based on a color combination as shown in FIG. 3B. In such processing, the color combination is used for a search query and the order of arrangement of parameter setting values set by each of the scroll bars 501a to 501d has no meaning in terms of generating a search query. However, the information processing apparatus 10 according to the present embodiment can have a meaning in the order of arrangement of each scroll bar.

FIG. 14 is an example of the display screen when the processing execution unit 109 of the information processing apparatus 10 further has the configuration as shown in FIG. 3A and the processing execution unit 109 provides a function to simulate color coordination of clothing. An object representing a user with clothing is displayed in the display screen and the color that can be selected by the user is displayed in each of the scroll bars 501a to 501d.

In this case, the scroll bars 501a to 501d are used to determine the color corresponding to the top, bottom, bag, and shoes of the object representing the user, respectively. That is, the example shown in FIG. 14 is an example in which the order of arrangement of scroll bars corresponds to the color coordination of clothing of each part and an example that gives a meaning to the order of arrangement of each scroll bar.

In such a case, the parameter setting unit 107 sets parameters representing a combination of colors based on the combination of colors positioned in the center position shown in FIG. 14 and outputs the parameters to the processing execution unit 109. The parameter acquisition unit 121 of the processing execution unit 109 acquires parameters output from the parameter setting unit 107 and representing the combination of colors and outputs the parameters to the data processing unit 123. The data processing unit 123 determines the color corresponding to each scroll bar and applies the specified color to the applicable location of the object representing the user. Accordingly, the combination of colors of the top, bottom, bag, and shoes in the object representing the user displayed in the display screen changes in real time.

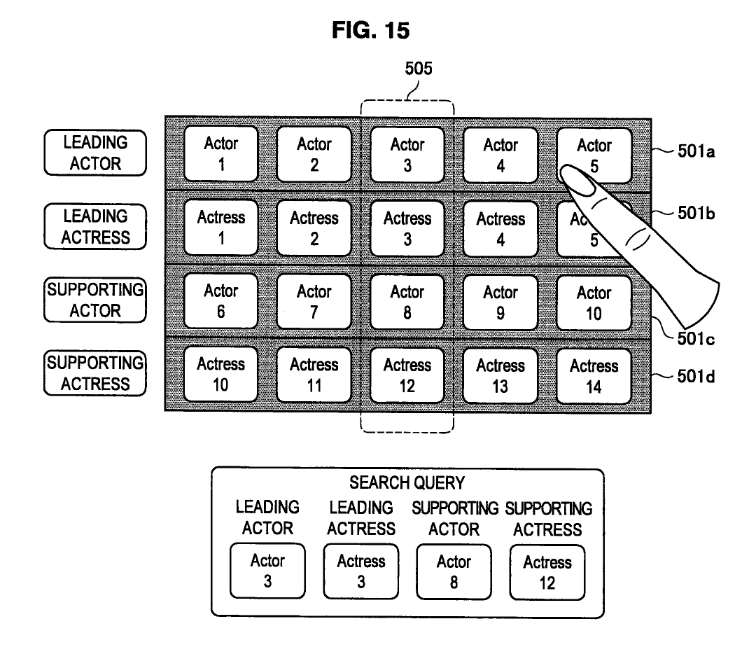

The processing execution unit 109 having the configuration shown in FIG. 3A may perform search processing of content based on parameters (search query) constituted of a combination of metadata by using the metadata associated with the content. More specifically, as shown in FIG. 15, the data processing unit 123 uses metadata about actors and actresses appearing in movie content and associates one piece of metadata such as leading actor, leading actress, supporting actor, and supporting actress with each of the scroll bars 501. Moreover, the data processing unit 123 arranges objects representing names or photos of actors and actresses in each of the scroll bars 501 following some order (for example, frame of actors/actresses or the number of times of appearance in movies).

If the user operates the scroll bar 501 by operating the operation body, the display control unit 111 causes a scroll bar adjacent to the scroll bar operated by the user to scroll to follow the scroll bar operated by the method taking a frictional force into consideration. Accordingly, if, for example, the user operates the scroll bar 501a about the leading actor in the direction in which more famous actors are displayed, the scroll bar 501b about the leading actress automatically scrolls in the direction in which more famous actresses are displayed.

The parameter setting unit 107 sets, for example, a combination 505 of objects positioned in the center of each of the scroll bars 501 as parameters representing a search query. In the example shown in FIG. 15, the parameter setting unit 107 outputs a combination of actors/actresses shown in the figure as a search query (parameters) to the parameter acquisition unit 121. The data processing unit 123 uses the acquired search query to search for applicable movie content from databases stored in the storage unit 113 or the like.

The user can also use pinning processing of a scroll bar described with reference to FIG. 13 in combination. Accordingly, the user can search for movie content while fixing the condition that in what role (role such as leading/supporting) the favorite actor or actress appears.

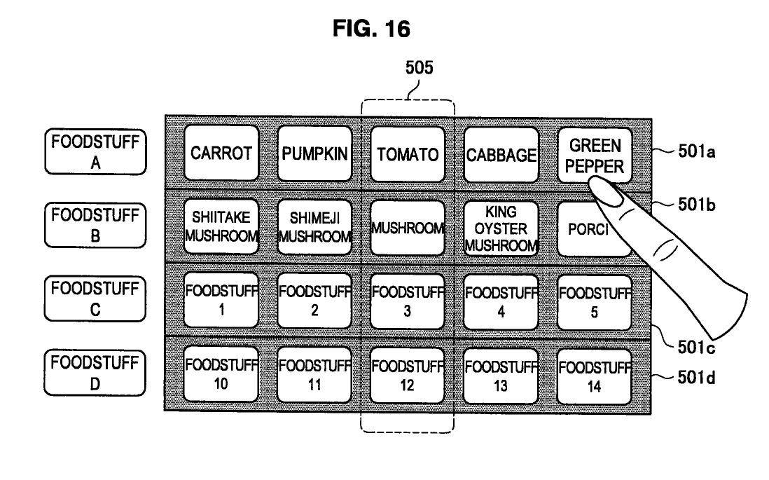

The processing execution unit 109 having the configuration shown in FIG. 3A may perform search processing of cooking recipes based on parameters (search query) constituted of a combination of foodstuffs. More specifically, as shown in FIG. 16, the data processing unit 123 associates one foodstuff with each of the scroll bars 501. Moreover, the data processing unit 123 arranges objects of names or photos of foodstuffs in each of the scroll bars 501 following some order (for example, the degree indicating the likelihood of being used for Western food or Japanese food).

If the user operates the scroll bar 501 by operating the operation body, the display control unit 111 causes a scroll bar adjacent to the scroll bar operated by the user to scroll to follow the scroll bar operated by the method taking a frictional force into consideration. Accordingly, if, for example, the user operates the scroll bar 501a about a foodstuff A in the direction in which more likely to be used for Western food, the scroll bar 501b about a foodstuff B automatically scrolls in the direction in which more likely to be used for Western food.

The parameter setting unit 107 sets, for example, the combination 505 of objects positioned in the center of each of the scroll bars 501 as parameters representing a search query. Accordingly, recipes for food that can be cooked with the combination of foodstuffs positioned in the center will be searched for from a database stored in the storage unit 113 or the like.

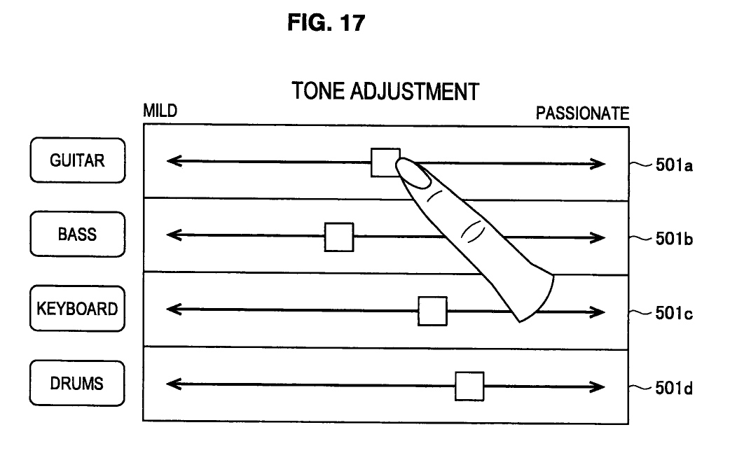

The processing execution unit 109 having the configuration shown in FIG. 3A may perform tone adjustment processing of music content based on parameters constituted of a combination of musical instruments. More specifically, as shown in FIG. 17, the data processing unit 123 associates one type of musical instrument constituting music content with each of the scroll bars 501. Moreover, the data processing unit 123 assigns a numeric value (parameter) representing a tone to each of the scroll bars 501 following some order (for example, in the order from a mild tone to a passionate tone).

If the user operates the scroll bar 501 by operating the operation body, the display control unit 111 causes a scroll bar adjacent to the scroll bar operated by the user to scroll to follow the scroll bar operated by the method taking a frictional force into consideration. Accordingly, if, for example, the user operates the scroll bar 501a about the guitar in the direction in which the tone becomes more passionate, the scroll bar 501b about the bass automatically scrolls in the same direction.

The parameter setting unit 107 sets, for example, parameters representing a combination of tones in accordance with the numeric value representing the tone corresponding to the position where an object is present in each of the scroll bars 501. The data processing unit 123 performs tone adjustment processing of music content based on parameters output from the parameter setting unit 107. Accordingly, the tone represented by parameters specified by the user is output from an output apparatus such as a speaker of the information processing apparatus 10.

The user can also use pinning processing of a scroll bar described with reference to FIG. 13 in combination. Accordingly, the user can perform tone adjustment processing of music content while fixing numeric values representing tones for musical instruments whose tone should not change.

In the foregoing, display control of the display screen exercised by the display control unit 111 according to the present embodiment has been described by citing examples.

FIGS. 9 to 17 illustrate a case when four scroll bars (objects for parameter settings) are displayed, but the number of objects for parameter settings displayed in the display screen is not limited to the above examples. FIGS. 9 to 17 also illustrate a case when scroll bars scroll in the horizontal direction, but the scroll direction of scroll bars is not limited to the horizontal direction. Further, concrete processing content shown in FIGS. 9 to 17 is only examples of processing performed by the processing execution unit 109 according to the present embodiment and processing performed by the processing execution unit 109 is not limited to the above examples.

The information processing apparatus 10 according to the present embodiment can similarly be realized by a so-called touch screen tablet.

### <Information Processing Method>

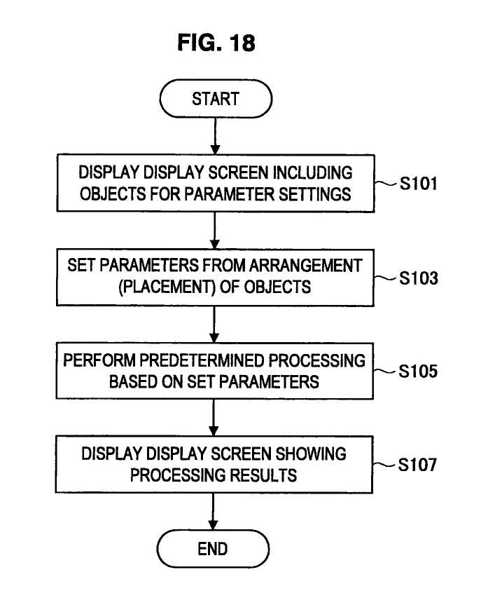

Next, the flow of the information processing method executed in the information processing apparatus 10 according to the present embodiment will briefly be described with reference to FIG. 18. FIG. 18 is a flowchart showing a flow of the information processing method according to the present embodiment.

First, the display control unit 111 of the information processing apparatus 10 displays the display screen including objects for parameter settings in cooperation with the processing execution unit 109 in a display unit such as a display (step S101). This display screen is a display screen in which, for example, as illustrated in FIG. 9, a plurality of objects for parameter settings are placed adjacent to each other along some direction.

The user operates objects for parameter settings by using the operation body such as a finger or stylus while viewing the display screen. When some object for parameter settings is operated, the display control unit 111 of the information processing apparatus 10 exercises display control of also an object adjacent to the operated object by the method that takes a pseudo frictional force described above into consideration. Accordingly, in addition to the object operated by the user, the object adjacent to the operated object automatically moves following the user's operation.

The parameter setting unit 107 determines arrangement (placement) of objects based on information about display positions of objects and display transitions acquired from the display control unit 111 and various kinds of information acquired from the input position detection unit 103 and the direction detection unit 105. Accordingly, the parameter setting unit 107 sets parameters used for processing performed by the processing execution unit 109 based on arrangement of objects (step S103). After parameters are set based on arrangement or placement of objects, the parameter setting unit 107 outputs information about set parameters to the processing execution unit 109.

The processing execution unit 109 performs predetermined processing (for example, searching of content, simulation of color coordination, searching of cooking recipes, or various kinds of data processing) based on parameters set by the parameter setting unit 107 (step S105). The processing execution unit 109 outputs processing results obtained by performing the predetermined processing to the display control unit 111. When processing results output from the processing execution unit 109 are acquired, the display control unit 111 displays the display screen including processing results in the display unit such as a display (step S107).

With the above information processing method executed, a plurality of parameters can efficiently be set without causing reduced operability in the information processing apparatus 10 according to the present embodiment.

### (Hardware Configuration)

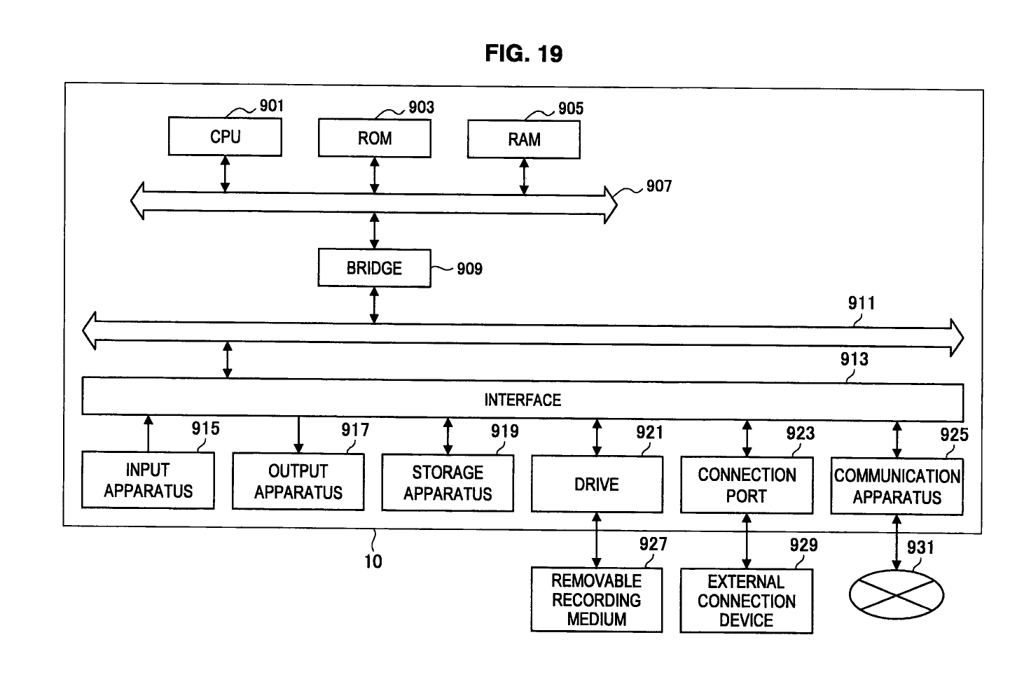

Next, the hardware configuration of the information processing apparatus 10 according to the embodiment of the present invention will be described in detail with reference to FIG. 19. FIG. 19 is a block diagram for illustrating the hardware configuration of the information processing apparatus 10 according to the embodiment of the present invention.

The information processing apparatus 10 mainly includes a CPU 901, a ROM 903, and a RAM 905. Furthermore, the information processing apparatus 10 also includes a host bus 907, a bridge 909, an external bus 911, an interface 913, an input device 915, an output device 917, a storage device 919, a drive 921, a connection port 923, and a communication device 925.

The CPU 901 serves as an arithmetic processing apparatus and a control device, and controls the overall operation or a part of the operation of the information processing apparatus 10 according to various programs recorded in the ROM 903, the RAM 905, the storage device 919, or a removable recording medium 927. The ROM 903 stores programs, operation parameters, and the like used by the CPU 901. The RAM 905 primarily stores programs that the CPU 901 uses and parameters and the like varying as appropriate during the execution of the programs. These are connected with each other via the host bus 907 configured from an internal bus such as a CPU bus or the like.

The host bus 907 is connected to the external bus 911 such as a PCI (Peripheral Component Interconnect/Interface) bus via the bridge 909.

The input device 915 is an operation means operated by a user, such as a mouse, a keyboard, a touch panel, buttons, a switch and a lever. Also, the input device 915 may be a remote control means (a so-called remote control) using, for example, infrared light or other radio waves, or may be an externally connected device 929 such as a mobile phone or a PDA conforming to the operation of the information processing apparatus 10. Furthermore, the input device 915 generates an input signal based on, for example, information which is input by a user with the above operation means, and is configured from an input control circuit for outputting the input signal to the CPU 901. The user of the information processing apparatus 10 can input various data to the information processing apparatus 10 and can instruct the information processing apparatus 10 to perform processing by operating this input apparatus 915.

The output device 917 is configured from a device capable of visually or audibly notifying acquired information to a user. Examples of such device include display devices such as a CRT display device, a liquid crystal display device, a plasma display device, an EL display device and lamps, audio output devices such as a speaker and a headphone, a printer, a mobile phone, a facsimile machine, and the like. For example, the output device 917 outputs a result obtained by various processings performed by the information processing apparatus 10. More specifically, the display device displays, in the form of texts or images, a result obtained by various processes performed by the information processing apparatus 10. On the other hand, the audio output device converts an audio signal such as reproduced audio data and sound data into an analog signal, and outputs the analog signal.

The storage device 919 is a device for storing data configured as an example of a storage unit of the information processing apparatus 10 and is used to store data. The storage device 919 is configured from, for example, a magnetic storage device such as a HDD (Hard Disk Drive), a semiconductor storage device, an optical storage device, or a magneto-optical storage device. This storage device 919 stores programs to be executed by the CPU 901, various data, and various data obtained from the outside.

The drive 921 is a reader/writer for recording medium, and is embedded in the information processing apparatus 10 or attached externally thereto. The drive 921 reads information recorded in the attached removable recording medium 927 such as a magnetic disk, an optical disk, a magneto-optical disk, or a semiconductor memory, and outputs the read information to the RAM 905. Furthermore, the drive 921 can write in the attached removable recording medium 927 such as a magnetic disk, an optical disk, a magneto-optical disk, or a semiconductor memory. The removable recording medium 927 is, for example, a DVD medium, an HD-DVD medium, or a Blu-ray medium. The removable recording medium 927 may be a CompactFlash (CF; registered trademark), a flash memory, an SD memory card (Secure Digital Memory Card), or the like. Alternatively, the removable recording medium 927 may be, for example, an IC card (Integrated Circuit Card) equipped with a non-contact IC chip or an electronic appliance.

The connection port 923 is a port for allowing devices to directly connect to the information processing apparatus 10. Examples of the connection port 923 include a USB (Universal Serial Bus) port, an IEEE1394 port, a SCSI (Small Computer System Interface) port, and the like. Other examples of the connection port 923 include an RS-232C port, an optical audio terminal, an HDMI (High-Definition Multimedia Interface) port, and the like. By the externally connected apparatus 929 connecting to this connection port 923, the information processing apparatus 10 directly obtains various data from the externally connected apparatus 929 and provides various data to the externally connected apparatus 929.

The communication device 925 is a communication interface configured from, for example, a communication device for connecting to a communication network 931. The communication device 925 is, for example, a wired or wireless LAN (Local Area Network), Bluetooth (registered trademark), a communication card for WUSB (Wireless USB), or the like. Alternatively, the communication device 925 may be a router for optical communication, a router for ADSL (Asymmetric Digital Subscriber Line), a modem for various communications, or the like. This communication device 925 can transmit and receive signals and the like in accordance with a predetermined protocol such as TCP/IP on the Internet and with other communication devices, for example. The communication network 931 connected to the communication device 925 is configured from a network and the like, which is connected via wire or wirelessly, and may be, for example, the Internet, a home LAN, infrared communication, radio wave communication, satellite communication, or the like.

Heretofore, an example of the hardware configuration capable of realizing the functions of the information processing apparatus 10 according to the embodiment of the present invention has been shown. Each of the structural elements described above may be configured using a general-purpose material, or may be configured from hardware dedicated to the function of each structural element. Accordingly, the hardware configuration to be used can be changed as appropriate according to the technical level at the time of carrying out the present embodiment.

### (Summary)

In an information processing apparatus and an information processing method according to the present embodiment, as described above, a plurality of objects for parameter settings is arranged in parallel to be adjacent to each other. When some object is operated by the user, another object adjacent to the operated object moves in the same direction by a certain amount based on a connection of a pseudo frictional force. Accordingly, the connection of objects adjacent to each other can be presented and also the burden of user's operations can be reduced.

In an information processing apparatus and an information processing method according to the present embodiment, when objects for parameter settings are operated, parameters to be fixed and parameters to be changed can explicitly be selected by the operation of an operation body. Such a method of setting parameters is more intuitive than setting methods of parameters using check boxes or other GUIs and can also realize operations with less burden for the user.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2010-087000 filed in the Japan Patent Office on Apr. 5, 2010, the entire content of which is hereby incorporated by reference.

What is claimed is:

1. An information processing apparatus comprising:
a display control unit that displays a plurality of objects for setting execution parameters when predetermined processing is performed in a display screen to be adjacent to each other and controls scrolling of the plurality of objects in the display screen in accordance with a user's operation;
a parameter setting unit that sets execution conditions for performing the predetermined processing in accordance with a combination of the objects positioned in predetermined positions in the display screen; and
a processing execution unit that performs the predetermined processing based on the execution conditions set by the parameter setting unit,
wherein the display control unit causes, when one of the objects is operated by the user's operation, the operated object and the object adjacent to the operated object to scroll in the display screen.

2. The information processing apparatus according to claim 1,
wherein a predetermined coefficient of static friction and a predetermined coefficient of dynamic friction are set to between the objects adjacent to each other, and
the display control unit calculates, when a scrolling speed of the operated object is a predetermined threshold calculated based on the coefficient of static friction or more, the scrolling speed of the adjacent object based on the coefficient of dynamic friction.

3. The information processing apparatus according to claim 1 or 2,
wherein the display control unit causes, when the user's operation performed on the operated object includes the operation in a direction parallel to a scroll direction and the operation in the direction perpendicular to the scroll direction, also the object adjacent to the operated object to scroll together.

4. The information processing apparatus according to claim 2,
wherein the display control unit calculates, when the scrolling speed of the adjacent object is the predetermined threshold or more, the scroll speed of the object further adjacent to the adjacent object based on the coefficient of dynamic friction.

5. The information processing apparatus according to claim 1,
wherein the display control unit causes, when a predetermined operation body is close to or in contact with the object adjacent to the operated object, only the operated object to scroll.

6. An information processing method, comprising the steps of
displaying a plurality of objects for setting execution parameters when predetermined processing is performed in a display screen to be adjacent to each other;
controlling scrolling of the objects in the display screen in accordance with a user's operation;
setting execution conditions for performing the predetermined processing in accordance with a combination of the objects positioned in predetermined positions in the display screen; and
performing the predetermined processing based on the set execution conditions,
wherein in the step of controlling scrolling, when one of the objects is operated by the user's operation, the operated object and the object adjacent to the operated object are scrolled in the display screen.

7. A program causing a computer to realize:
a display control function that displays a plurality of objects for setting execution parameters when predetermined processing is performed in a display screen to be adjacent to each other, controls scrolling of the plurality of objects in the display screen in accordance with a user's operation, and when one of the objects is operated by the user's operation, causes the operated object and the object adjacent to the operated object to scroll in the display screen;
a parameter setting function that sets execution conditions for performing the predetermined processing in accordance with a combination of the objects positioned in predetermined positions in the display screen; and
a processing execution function that performs the predetermined processing based on the execution conditions set by the parameter setting function.
